(19) United States
(12) Patent Application Publication
(10) Pub. No.: US 2006/0083509 A1
(43) Pub. Date: Apr. 20, 2006

(54) Image-taking optical system

(75) Inventor: Mitsuaki Shimo, Osaka (JP)

Correspondence Address: SIDLEY AUSTIN LLP, 717 NORTH HARWOOD, SUITE 3400, DALLAS, TX, 75201, US

(73) Assignee: KONICA MINOLTA OPTO, Inc.

(21) Appl. No.: 11/252,352

(22) Filed: Oct. 17, 2005

(30) Foreign Application Priority Data
Oct. 19, 2004 (JP) 2004-303712

(51) Int. Cl. G03B 7/099

(52) U.S. Cl. 396/268

(57) ABSTRACT

An image-taking optical system for forming an optical image of an object on the light-receiving surface of an image sensor includes at least one optical prism in which light from the object side enters through an entrance surface, is then reflected by at least three reflection surfaces each formed with a curved surface, and subsequently exits from an exit surface. At least one of the reflection surfaces is provided with an optical aperture stop. At least one of the reflection surfaces is a rotationally asymmetrical surface so arranged as to be off-centered.

This application is based on Japanese Patent Application No. 2004-303712 filed on Oct. 19, 2004, the contents of which are hereby incorporated by reference.

### BACKGROUND OF THE INVENTION

1. Field of the Invention

The present invention relates to an image-taking optical system. More particularly, the present invention relates to a slim-type image-taking optical system suitable for, for example, a digital appliance equipped with an image capturing capability that captures an image of a subject with an image sensor.

2. Description of Related Art

In recent years, more and more cellular phones and personal digital assistants (PDAs) have been equipped with a built-in digital still camera or a built-in digital video unit for taking in images. There has been a growing demand for such digital appliances to be more downsized in view of portability but also to offer a higher performance in providing image information. To achieve a higher performance in providing image information, the number of pixels included in the image sensor which takes in images has been increased. Following this increase in the number of pixels included in the image sensor, downsizing of an element composing one pixel has also been in development. However, the overall size of the image sensor inevitably increases, resulting in an increase in the required image size and further a higher resolution required for the increased number of pixels. As a conventional image-taking optical system, a coaxial optical system called a straight-type optical system has been used. With this type, increasing the image size and the resolution involves an increase in the number of lenses used and an increase in the full length, which can be assumed to go against the downsizing of cellular phones and PDAs. Therefore, approaches to downsizing and slimming-down needs to be made by using not the straight type but a different type of an image-taking optical system.

As an image-taking optical system of a type different from the straight type, an optical system that employs a prism having a reflection surface is well-known. With this type, downsizing and slimming-down of the image-taking optical system is achieved by bending an optical path with the reflection surface. Methods of bending an optical path include repeating reflection within one prism, arranging a plurality of prisms so as to perform reflection a plurality of times, and the like. For example, patent document 1 proposes an image-taking optical system employing two prisms for the purpose of slimming down the entire size thereof. Patent document 2 proposes an image-taking optical system employing one prism for the purpose of cost reduction.

[Patent Document 1] Japanese Patent Application Laid-open No. 2003-84200

[Patent Document 2] Japanese Patent Application Laid-open No. H11-23971

The image-taking optical system described in patent document 1 suffers from a high cost due to the use of two prisms therein, and, in addition, provokes a problem of a cost increase caused by an increase in the number of components used due to the arrangement of an aperture stop between the two prisms. The image-taking optical system described in patent document 2 is advantageous in cost reduction due to its one-prism structure and also has the potential for further cost reduction due to the arrangement of the aperture stop in the prism. However, this image-taking optical system, though being slimmed down to some degree, is not well adapted for a further increase in the number of pixels and a larger angle of view. That is, the inappropriate arrangement of the prism results in a failure to provide a well-slimmed-down structure and also a failure to maintain a high performance.

### SUMMARY OF THE INVENTION

In view of the problem described above, the present invention has been made, and it is an object of the invention to provide an image-taking optical system that is low-cost and slim and also provides a sufficiently high performance for an image sensor having a great number of pixels.

To achieve the object described above, according to one aspect of the present invention, an image-taking optical system for forming an optical image of an object on the light-receiving surface of an image sensor includes at least one optical prism in which light from the object side enters through an entrance surface, is then reflected by at least three reflection surfaces each formed with a curved surface, and subsequently exits from an exit surface. At least one of the reflection surfaces is provided with an optical aperture stop. At least one of the reflection surfaces is a rotationally asymmetrical surface so arranged as to be off-centered.

According to another aspect of the invention, an image-taking lens apparatus includes an image-taking optical system for forming an optical image and an image sensor for converting into an electrical signal the optical image formed by the image-taking lens system. The image-taking optical system includes at least one optical prism in which light from the object side enters through an entrance surface, is then reflected by at least three reflection surfaces each formed with a curved surface, and subsequently exits from an exit surface. At least one of the reflection surfaces is provided with an optical aperture stop. At least one of the reflection surfaces is a rotationally asymmetrical surface so arranged as to be off-centered.

### BRIEF DESCRIPTION OF THE DRAWINGS

FIG. 1 is an optical path diagram of a first embodiment (Example 1) according to the present invention;

FIG. 2 is an optical path diagram of a second embodiment (Example 2) according to the invention;

FIG. 3 is an optical path diagram of a third embodiment (Example 3) according to the invention;

FIG. 4 is an optical path diagram of a fourth embodiment (Example 4) according to the invention;

FIG. 5A to 5F are X-direction lateral aberration diagrams of Example 1;

FIG. 6A to 6F are Y-direction lateral aberration diagrams of Example 1;

FIG. 7A to 7F are X-direction lateral aberration diagrams of Example 2;

FIG. 8A to 8F are Y-direction lateral aberration diagrams of Example 2;

FIG. 9A to 9F are X-direction lateral aberration diagrams of Example 3;

FIG. 10A to 10F are Y-direction lateral aberration diagrams of Example 3;

FIG. 11A to 11F are X-direction lateral aberration diagrams of Example 4; and

FIG. 12A to 12F are Y-direction lateral aberration diagrams of Example 4.

### DETAILED DESCRIPTION OF PREFERRED EMBODIMENTS

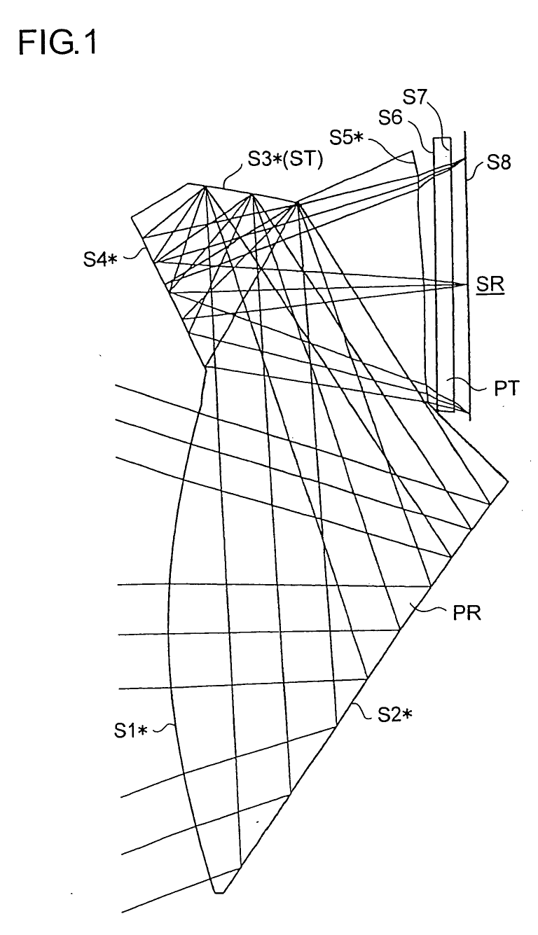

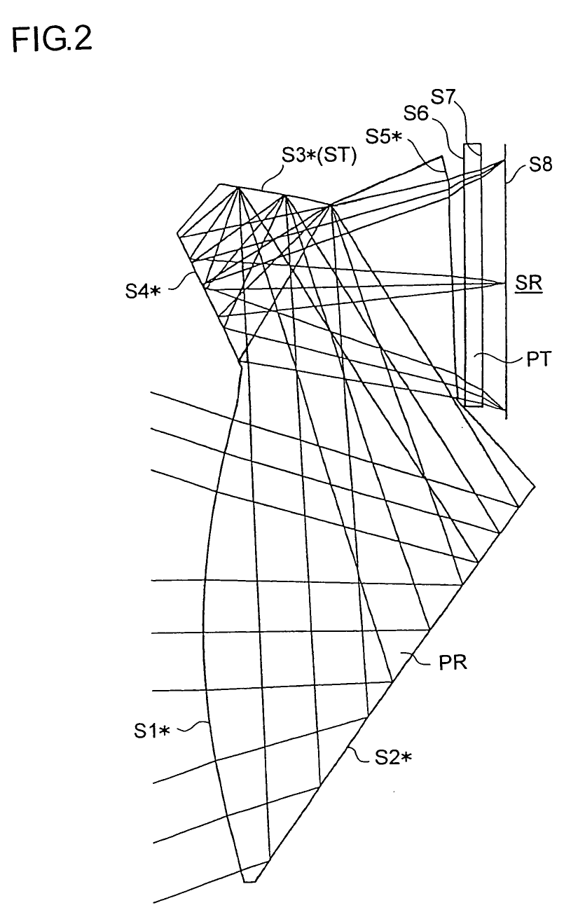

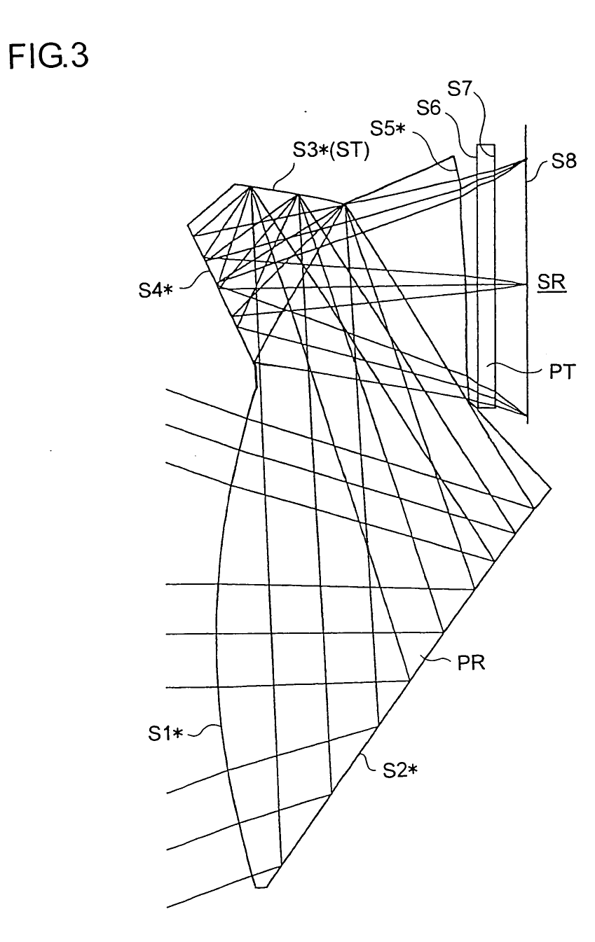

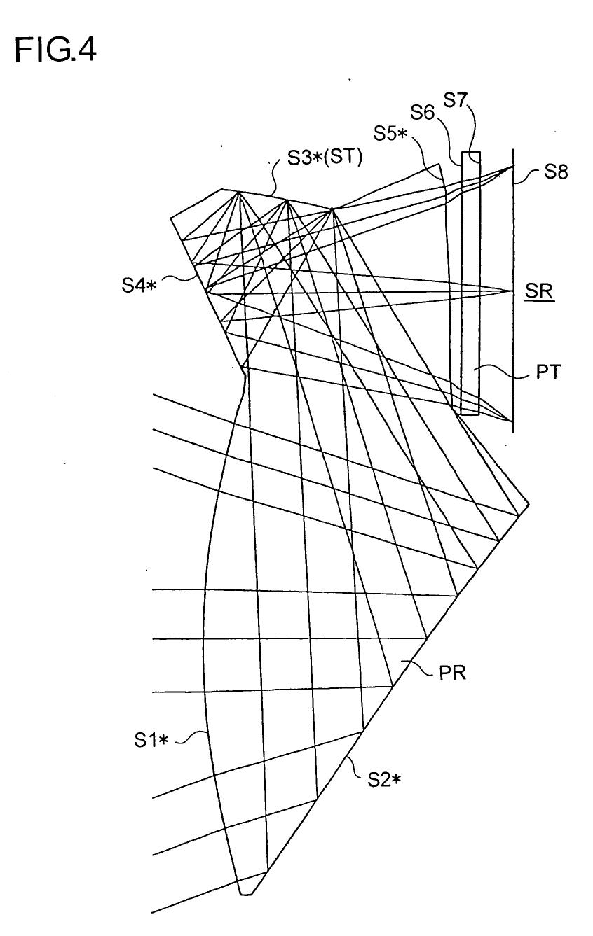

Embodiments of an image-taking optical system according to the present invention will be described below with reference to the accompanying drawings. FIGS. 1 to 4 show the optical structure of the first to fourth embodiments, respectively, in optical cross-sections. In FIGS. 1 to 4, a surface indicated by Si (i=1, 2, 3, . . . ) is the i-th surface counted from the object side, and a surface whose symbol Si is marked with an asterisk (*) is a free curved surface. Each of the image-taking optical systems of the embodiments includes one optical prism PR functioning as a fixed focal length lens that forms an optical image of an object, i.e., a subject, on the light-receiving surface (i.e., image-sensing surface) of an image sensor SR, for example, a solid-state image sensor such as a CCD (charge coupled device). This optical prism PR has an optical aperture stop ST arranged on a third surface S3 thereof and a parallel-plane plate PT (corresponding to an optical filter such as an optical low-pass filter or infrared cut filter arranged as required, the cover glass of an image sensor SR, or the like) arranged on the image side thereof.

The optical structure of the first to fourth embodiments will be described along an optical path. A first surface S1, which is located on the most object side in the image-taking optical system, is an entrance surface of the optical prism PR. Light entering through the first surface S1 is reflected on a second surface S2, a reflection surface, and is thereby directed toward a third surface S3, a reflection surface serving also as the optical aperture stop ST. This optical aperture stop ST is circular-shaped in the first to third embodiments and oval-shaped in the fourth embodiment. Although the third and fourth embodiments are identical in the arrangement and shape of surfaces, but are different in the shape of the aperture stop ST as described above. The light reflected on the third surface S3 travels toward and then is reflected on a fourth surface S4. The light reflected on the fourth surface S4 exits from a fifth surface S5. The first to fifth surfaces S1 to S5 are all free curved surfaces. The light exiting from the fifth surface S5 is transmitted through a sixth surface S6 and a seventh surface S7 of the parallel-plane surface PT, and then reaches an image surface (eighth surface) S8, whereby an optical image of a subject is formed on the light-receiving surface of the image sensor SR. The formed optical image is then converted into an electrical signal by the image sensor SR.

To achieve downsizing and slimming-down of an optical system, the optical path may be bent, for which the use of a reflection surface is effective. However, the reflection surface needs to be appropriately arranged to bend the optical path, otherwise the slimming-down cannot be achieved. In addition, the arrangement of a plurality of optical prisms for achieving a higher performance results in a reverse effect leading to upsizing of the optical system. Thus, to achieve a higher performance by use of an optical prism, at least one optical prism having at least three reflection surfaces in addition to an entrance surface and an exit surface is required. It is preferable to arrange at least one of these three reflection surfaces in an off-centered manner.

Chromatic aberration occurs on the entrance and exit surfaces of an optical prism. To achieve a higher performance, it is very important to correct chromatic aberration to the best possible extent. On a reflection surface, no aberration occurs; therefore, increasing the optical power of the reflection surface permits smaller optical powers of the entrance and exit surfaces, thereby permitting smaller overall chromatic aberration. However, an increase in the optical power of one reflection surface causes large coma aberration or the like. Thus, the optical power of the reflection surface needs to be shared by a plurality of surfaces; therefore, a plurality of refection surfaces are required for an optical prism.

From the viewpoint of aberration correction, the arrangement of the optical aperture stop in particular is important, especially for correction of distortion, coma aberration, and lateral chromatic aberration. As for the correction of distortion among those described above, negative distortion tends to occur when the optical aperture stop is arranged in the front area of the image-taking optical system while positive distortion tends to occur when the optical aperture stop is arranged in the rear area of the image-taking optical system. Moreover, it is very difficult to correct aberration when the optical aperture stop is arranged in the most front or rear position of the image-taking optical system. Therefore, it is preferable to arrange the optical aperture stop in the inner area of the image-taking optical system in order to achieve a higher performance. For the cost aspect, it is more advantageous to provide a reflection surface functioning as an optical aperture stop than to provide an optical aperture stop as one component.

Providing an optical arrangement of the image-taking optical system with a structure substantially symmetrical, in the front-back direction, with respect to the surface of the aperture stop is very advantageous in correcting the aberration described above and the like. When one of the reflection surfaces is provided as an aperture surface, it is advantageous in terms of aberration correction to arrange the remaining reflection surfaces, one each, in front of and behind the aperture surface. Thus, it is preferable to provide at least three reflection surfaces. Although it is preferable, for the purpose of achieving a higher performance, to provide a structure such that reflection surfaces are positioned with an optical aperture stop in between, the structure to be adopted is not limited to this structure. To achieve a higher performance, it is also possible to arrange a reflection surface and further a refraction surface that are each provided with an appropriate optical power with respect to the reflection surface functioning as the optical aperture stop. In addition to the optical aperture stop, a beam restricting plate or the like for cutting unnecessary light may be arranged as necessary.

Aiming at slimming-down with a structure such that the optical path is bent with an optical prism requires a surface that is arranged in an off-centered manner. Employing the off-centered arrangement causes aberration asymmetrical with respect to the optical axis, which does not occur in a straight-type system. This asymmetrical aberration cannot be corrected satisfactorily with a structure in which only rotationally symmetrical surfaces are included; therefore, a rotationally asymmetrical surface is required for this correction. Thus, in each of the embodiments, the second to fourth surfaces S2 to S4 serve as rotationally asymmetrical surfaces arranged in an off-centered manner.

From the viewpoint described above, as in each of the embodiments, it is preferable that at least one prism be provided in which light from the object side enters through the entrance surface thereof, is then reflected on at least three reflection surfaces each formed with a curved surface, and subsequently exits from the exit surface thereof; that an optical aperture stop be arranged on any one of the reflection surfaces; and that at least one of the reflection surfaces is a rotationally asymmetrical surface arranged in an off-centered manner. This structure permits achieving an image-taking optical system that is low-cost and slim and also that offers a high performance for an image sensor having a great number of pixels.

For the reflection surface provided with the optical aperture stop, it is preferable that only the area within the effective diameter of the optical aperture stop be subjected to reflective coating. This permits cutting light directed to the area outside the effective diameter of the aperture stop, which requires no increase in the number of components, thus permitting a low-cost structure. Moreover, roughly forming the surface outside the effective diameter of the optical aperture stop for the purpose of scattering light permits only light directed to within the effective diameter of the aperture stop to be subjected to reflection. Other methods of subjecting to reflection only light directed to within the effective diameter of the aperture stop include: a method of subjecting the area outside the effective diameter of the aperture stop to blackening treatment so as to cut light directed to this area, and a method of subjecting the area outside the effective diameter of the aperture stop to chemical processing so as to blacken this area or to provide this area with light-absorbing properties. The use of these methods can provide the same effects as described above.

As in each of the embodiments, it is preferable that the image-taking optical system have only one optical prism. The use of a plurality of optical prisms for the purpose of achieving a higher performance results in a cost increase as well as upsizing. A structure with one optical prism is the most inexpensive structure. Moreover, the adoption of one optical prism is advantageous in slimming down the image-taking optical system.

For slimming-down of the image-taking optical system, it is preferable that conditional formula (1) below be fulfilled.
D/H<2.0 (1)
where
H represents the length of a screen of the image sensor along the shorter side thereof, and
D represents the length in the direction perpendicular to the screen of the image sensor from the image sensor to an intersection, among the intersections of the prism surfaces and rays of light, which is located on the most object side in the direction perpendicular to the screen of the image sensor.

The conditional formula (1) defines a preferable conditional range in regard to the slimming-down of the image-taking optical system. In the first to fourth embodiments, in an orthogonal coordinate system (X, Y, Z) to be described later, D represents the length in the Z direction from the intersection, among the intersections of the fourth surface S4 and the rays, which is located on the most objected side in the Z direction to the image sensor SR, and this length D corresponds to the substantial thickness of the image-taking optical system. An increase in the number of pixels included in the image sensor increases the required image range accordingly, which involves upsizing of the image-taking optical system. If this conditional formula (1) is fulfilled, the slimming-down of the image-taking optical system can be maintained effectively. Disregarding the conditional range defined by the conditional formula (1) results in insufficient slimming-down.

It is further preferable that conditional formula (1a) below be fulfilled.
D/H<1.5 (1a)
This conditional formula (1a) defines, within the conditional range defined by the conditional formula (1), a conditional range further preferable out of the above-stated points and other considerations. If the conditional formula (1a) is fulfilled, even further slimming-down can be achieved.

In each of the embodiments, the first surface S1 to the fifth surface S5 are each formed with a free curved surface. In an optical prism having a plurality of reflection surfaces as described above, it is preferable that free curved surfaces be used as prism surfaces, and further preferable that curved surfaces forming the reflection surfaces of the optical prism be free curved surfaces. When using a reflection surface in the optical system, attention needs to be given to the occurrence of asymmetrical aberration. In a case where a flat mirror performs reflection with an angle of incidence of 45 degrees with respect to the optical axis, aberration asymmetrical with respect to the optical axis does not occur. However, in some other cases, the asymmetrical aberration may occur, especially when a mirror (curved mirror in particular) is used in an off-axial system of a so-called “displaced-axis” type. Such asymmetrical aberration cannot be corrected on an axisymmetric curved surface sufficiently, thus requiring its correction by use of a non-axisymmetric curved surface. Therefore, it is preferable to use a free curved surface as a curved surface. It is further preferable that a non-axisymmetric curved surface (i.e., free curved surface) be used as a curved surface which is also used as a reflection surface.

In the fourth embodiment, the optical aperture stop is formed into not a circular shape but into a different shape. For example, in a case of a axisymmetric optical system (coaxial optical system), the brightness of an optical system is represented by an angle of incidence of peripheral light (marginal ray) on the image surface with respect to light (on-axis principal ray) passing through the optical axis. The principal ray is typically a ray passing through the center of the optical aperture stop. The marginal ray is typically a ray passing through the peripheral area of the optical aperture stop. In a case of a coaxial optical system, a circular-shaped aperture stop is typically used so that the marginal ray becomes symmetrical with respect to the optical axis. However, when a circular-shaped aperture stop is used in the non-axisymmetric optical system, the angle of incidence of the marginal ray on the image surface varies in many cases, depending on its incidence direction on the image surface. Thus, when a circular-shaped aperture stop is used, the brightness of the optical system may become non-uniform among rays incident in different directions on the image surface. To eliminate this non-uniformness among rays incident in different directions so as to achieve uniformness, it is preferable that the optical aperture stop be formed not into a circular shape but into a shape that permits the angle of incidence to be substantially uniform among marginal rays incident in different directions.

In the fourth embodiment, the optical aperture stop is formed into an oval shape. In a case of an optical system constructed with a curved surface (including a plane surface) symmetrical to a certain surface, rays of light travel symmetrically with respect to this surface. Therefore, providing different diameters for the direction symmetrical to the surface and the direction perpendicular thereto permits substantially uniform brightness of the image-taking optical system irrespectively of direction difference. Thus, if the image-taking optical system is symmetrical with respect to a certain surface, the use of an optical aperture stop formed into an oval shape that has axes in the direction of the aforementioned surface and the direction perpendicular thereto permits reducing non-uniformness in the brightness of the image-taking optical system due to a direction difference.

In the image-taking optical system of each of the embodiments, refractive lens surfaces that deflect rays incident thereon by refraction (that is, lens surfaces on which light is deflected at the interface between two media having different refractive indices) are used. Any of those lens surfaces, however, may be replaced with a lens surface of any other type, for example: a diffractive lens surface, which deflects rays incident thereon by diffraction; or a refractive-diffractive hybrid lens surface, which deflects rays incident thereon by the combined effect of refraction and diffraction; and the like.

The image-taking optical system of each of the embodiments is suitable for use as a slim image-taking optical system for a digital appliance equipped with an image capturing capability (for example, a camera-equipped cellular phone). Combining this image-taking optical system with an image sensor or the like permits structuring an image-taking lens apparatus that optically captures a picture image of a subject and then outputs the image as an electrical signal. The image-taking lens apparatus is an optical apparatus that serves as a main component of a camera used for photographing a still image and a moving image of a subject. The image-taking lens apparatus is composed of, from the object (subject) side, for example, an image-taking optical system that forms an optical image of an object, and an image sensor that converts the optical image formed by the image-taking optical system into an electrical signal.

Used as the image sensor is a solid-state image sensor such as a CCD (charge-coupled device) or a CMOS (complementary metal-oxide-semiconductor) sensor having a plurality of pixels. An optical image formed by the image-taking optical system is converted into an electrical signal by the image sensor. The signal produced by the image sensor is, after being subjected to predetermined digital image processing, image compression processing, or other processing as necessary, recorded as a digital video signal in a memory (such as a semiconductor memory or an optical disk), and is then, as the case may be, transmitted to another appliance via a cable or after being converted into an infrared signal. Between the image-taking optical system and the image sensor, an optical filter (such as an optical low-pass filter or an infrared cut filter) is arranged as necessary.

Examples of cameras include digital cameras, video cameras, surveillance cameras, car-mounted cameras, cameras for videophones, cameras for intercoms, and cameras incorporated in or externally fitted to personal computers, mobile computers, cellular phones, personal digital assistants (PDAs), peripheral devices therefor (such as mouses, scanners, printers, and the like), other digital appliances, and the like. As these examples show, by the use of an image-taking lens apparatus, it is possible not only to build a camera but also to incorporate an image-taking lens apparatus in various devices to provide them with a camera capability. It is also possible to use an image-taking lens apparatus in a required manner so as to realize a camera capability. For example, an image-taking lens apparatus as a unit may be configured so as to be freely attachable to and detachable from, or rotatable relative to a camera body, or it may be configured so as to be freely attachable to and detachable from, or rotatable relative to a personal digital appliance (such as a cellular phone or a PDA).

As is understood from the above description, the following constructions are included in each of the embodiments described above and examples to be described below. These constructions permit achieving a low-cost, slim, and compact image-taking lens apparatus that provides a satisfactory optical performance. The application of this image-taking lens apparatus to a camera, a digital appliance, or the like can contribute to performance enhancement, function enhancement, cost reduction, and downsizing of this appliance.

(T1) An image-taking lens apparatus comprising an image-taking optical system for forming an optical image and an image sensor for converting into an electrical signal the optical image formed by the image-taking lens system, wherein the image-taking optical system comprises at least one optical prism in which light from an object side enters through an entrance surface, is then reflected by at least three reflection surfaces each formed with a curved surface, and subsequently exits from an exit surface, wherein at least one of the reflection surfaces is provided with an optical aperture stop, and wherein at least one of the reflection surfaces is a rotationally asymmetrical surface that is arranged in an off-centered manner.

(T2) The image-taking lens apparatus as described in (T1) above, wherein only one optical prism is provided.

(T3) The image-taking lens apparatus as described in either of (T1) or (T2) above, wherein the conditional formula (1) or (1a) is fulfilled.

(T4) The image-taking lens apparatus as described in any one of (T1) to (T3) above, wherein the curved surface is a free curved surface.

(T5) The image-taking lens apparatus as described in any one of (T1) to (T4) above, wherein the optical aperture stop is formed into a shape different from a circular shape.

(T6) The image-taking lens apparatus as described in (T5) above, wherein the optical aperture stop is formed into an oval shape.

(C1) A camera, which comprises the image-taking lens apparatus as described in any one of (T1) to (T6) above and is used for photographing at least one of a still image and a moving image of a subject.

(C2) The camera as described in (C1) above, corresponding to any of a digital camera, a video camera, and a camera incorporated in or externally fitted to any of a cellular phone, a personal digital assistant, a personal computer, a mobile computer, and a peripheral device therefor.

(D1) A digital appliance, comprising the image-taking lens apparatus as described in any one of (T1) to (T6) above to be thereby provided with at least one of capabilities of photographing a still image of a subject and photographing a moving image of a subject.

(D2) The digital appliance as described in (D1) above, corresponding to any of a cellular phone, a personal digital assistant, a personal computer, a mobile computer, and a peripheral device therefor.

### EXAMPLES

Hereinafter, practical examples of the image-taking optical system embodying the present invention will be presented with reference to their construction data and other data. Examples 1 to 4 presented below are numerical examples corresponding respectively to the first to fourth embodiments described above. Thus, optical path diagrams (FIGS. 1 to 4) showing the first to fourth embodiments also show the optical paths, optical constructions, and the like of Examples 1 to 4, respectively.

Tables 1 to 12 show the construction data of Examples 1 to 4. In the basic optical construction shown in Tables 1, 4, 7, and 10 (where i represents the surface number), Si (i=1, 2, 3, . . . ) represents the i-th surface counted from the object side; ri (i=1, 2, 3, . . . ) represents the curvature of field (in mm) of the surface Si; Ni (i=1, 2, 3, . . . ); and νi (i=1, 2, 3, . . . ) represent the refractive index (Nd) for the d-line and the Abbe number (νd), respectively, of the optical material that fills the axial distance between the i-th surface Si and (i+1)th surface Si+1 counted from the object side.

The arrangement of each surface Si in the Examples 1 to 4 is determined by the coordinates of a vertex and angle of rotation of each surface Si as shown in Tables 2, 5, 8, and 11. The surface data is expressed based on a right-handed orthogonal coordinate system (X, Y, Z). In the orthogonal coordinate system (X, Y, Z), a ray passing through the center of the object surface and the center of the image surface is defined as a base ray, the point of intersection of the base ray and the first surface S1 is defined as an origin point (0, 0, 0), and the Z direction is defined as the direction in which the base ray extends from the object surface center toward the point of intersection with the first surface S1, which direction is positive. In each of the optical path diagrams (FIGS. 1 to 4), the X-axis direction is perpendicular to the paper surface (with the direction extending from the front toward rear surface of the paper being defined as positive and with the counter-clockwise rotation as facing toward the paper surface being defined as positive X rotation), the Y-axis direction is a direction by which the right-handed system is formed together with the X-axis and the Z-axis (i.e., parallel to the paper surface). The vertex position of each surface is represented by coordinates of the vertex (X, Y, Z coordinates) (in mm). The inclination of each surface is represented by angles (in °) of rotations about X, Y, and Z axes (X rotation, Y rotation, and Z rotation) with respect to the vertex of the surface. The directions counter-clockwise with respect to the X axis and Y axis as viewed toward the positive direction are positive directions of angles of the X and Y rotations, respectively. The direction clockwise with respect to the Z axis as viewed toward the positive direction is a positive direction of the angle of the Z rotation.

In Tables 1, 4, 7, and 10, a surface Si marked with an asterisk * is a free curved surface and defined by formula (FS) below adopting a local orthogonal coordinate system (x, y, z) with the origin point located at the vertex of the surface. Tables 3, 6, 9, and 12 show free curved surface data of each Example. Here, it should be noted that the coefficient of any term that does not appear in the tables is equal to zero (k is equal to zero for all the free curved surfaces), and that, for all the data, E-n stands for ×10^{-n,,}.

$$z = c \cdot {h}^{2} / \{ 1 + \sqrt{1 + ( 1 + k ) {c}^{2} {h}^{2}} \} + {\sum }_{j = 2}^{66} {C}_{j} {x}^{m} {y}^{n} \qquad ( FS )$$

where
z represents the displacement in the z-axis direction at the height h (relative to the vertex);
h represents the height in a direction perpendicular to the z-axis (h²=x²+y²);
c represents the paraxial curvature (=the reciprocal of the radius of curvature);
k represents the conic coefficient; and
Cj represents the coefficient.
The term of a free curved surface is represented by formula (FC) below.

$${\sum }_{j = 2}^{66} {C}_{j} {x}^{m} {y}^{n} = {C}_{2} \cdot x + {C}_{3} \cdot y + {C}_{4} \cdot {x}^{2} + {C}_{5} \cdot x \cdot y + {C}_{6} \cdot {y}^{2} + {C}_{7} \cdot {x}^{3} + {C}_{8} \cdot {x}^{2} \cdot y + {C}_{9} \cdot x \cdot {y}^{2} + {C}_{10} \cdot {y}^{3} + {C}_{11} \cdot {x}^{4} + {C}_{12} \cdot {x}^{3} \cdot y + {C}_{13} \cdot {x}^{2} \cdot {y}^{2} + {C}_{14} \cdot x \cdot {y}^{3} + {C}_{15} \cdot {y}^{4} + {C}_{16} \cdot {x}^{5} + {C}_{17} \cdot {x}^{4} \cdot y + {C}_{18} \cdot {x}^{3} \cdot {y}^{3} + {C}_{19} \cdot {x}^{2} \cdot {y}^{3} + {C}_{20} \cdot x \cdot {y}^{4} + {C}_{21} \cdot {y}^{5} + {C}_{22} \cdot {x}^{6} + {C}_{23} \cdot {x}^{5} \cdot y + {C}_{24} \cdot {x}^{4} \cdot {y}^{2} + {C}_{25} \cdot {x}^{3} \cdot {y}^{3} + {C}_{26} \cdot {x}^{2} \cdot {y}^{4} + {C}_{27} \cdot x \cdot {y}^{5} + {C}_{28} \cdot {y}^{6} + … \qquad ( FC )$$

In Table 13, the focal length f (in mm) and f-number (FNO) of the entire system are indicated for each example, with the diameter (in mm) of the optical aperture stop ST, the half angle of view (in °), the size (in mm) of the image-sensing surface, and values for conditional formulae. In Example 4, the optical aperture stop ST is formed into an oval shape, the X direction corresponds to the diameter of the aperture stop along its shorter axis while the Y direction corresponds to the diameter of the aperture stop along its longer axis. For the half angle of view and the size of the image-sensing surface, the X direction corresponds to the horizontal direction (along the longer side of the screen) while the Y direction corresponds to the vertical direction (along the shorter side of the screen).

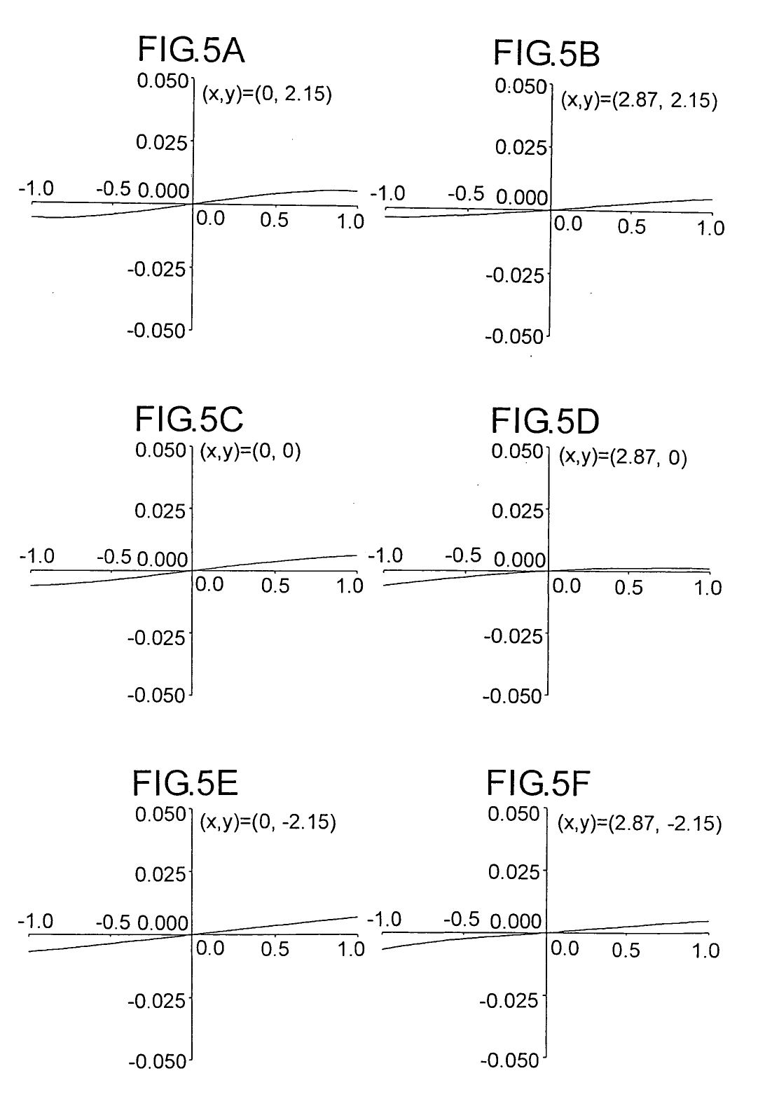

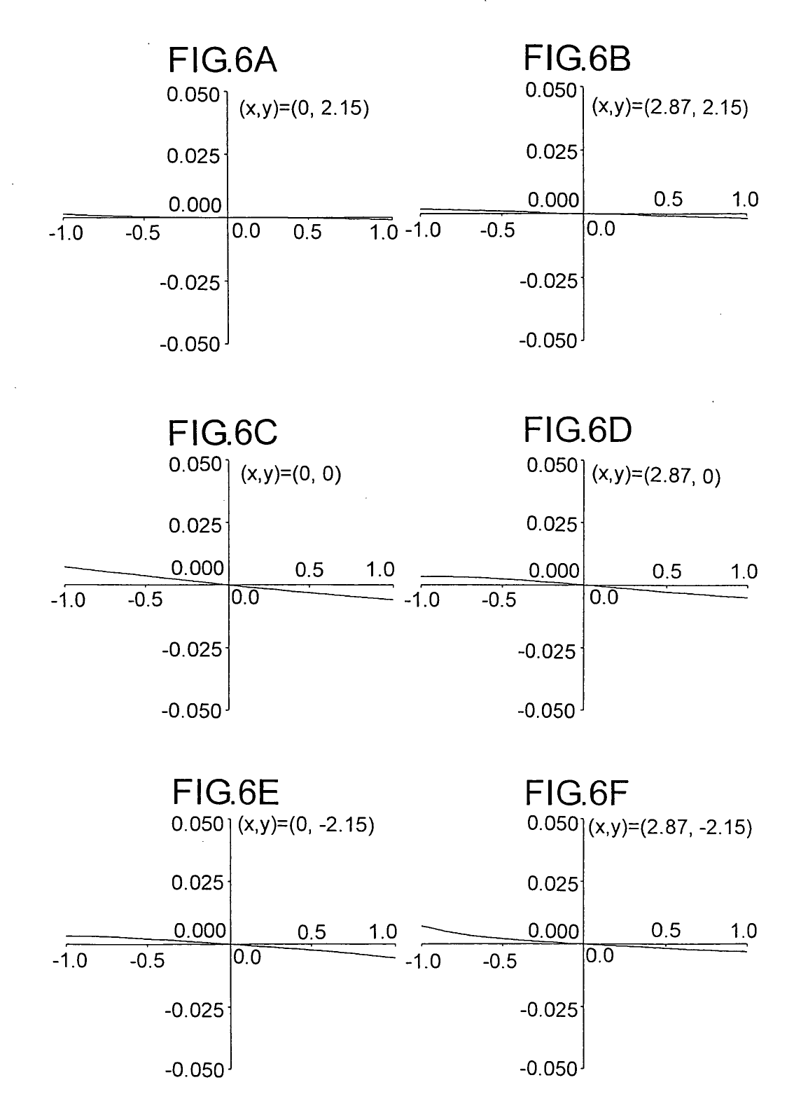

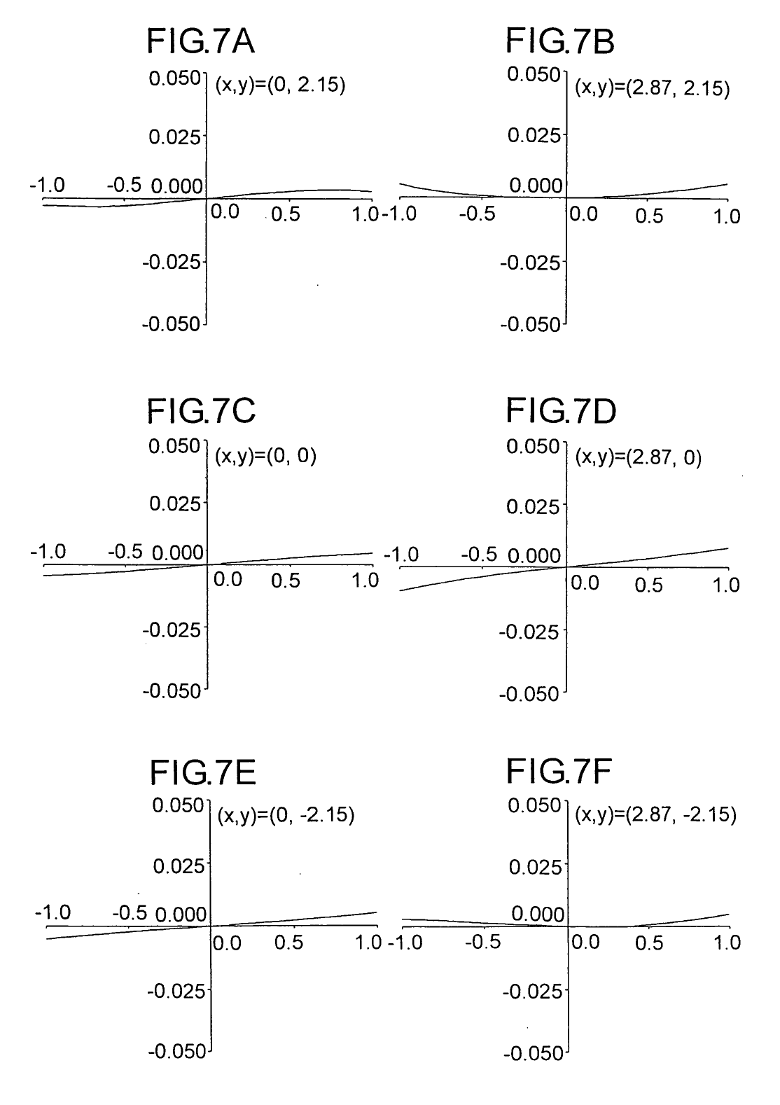

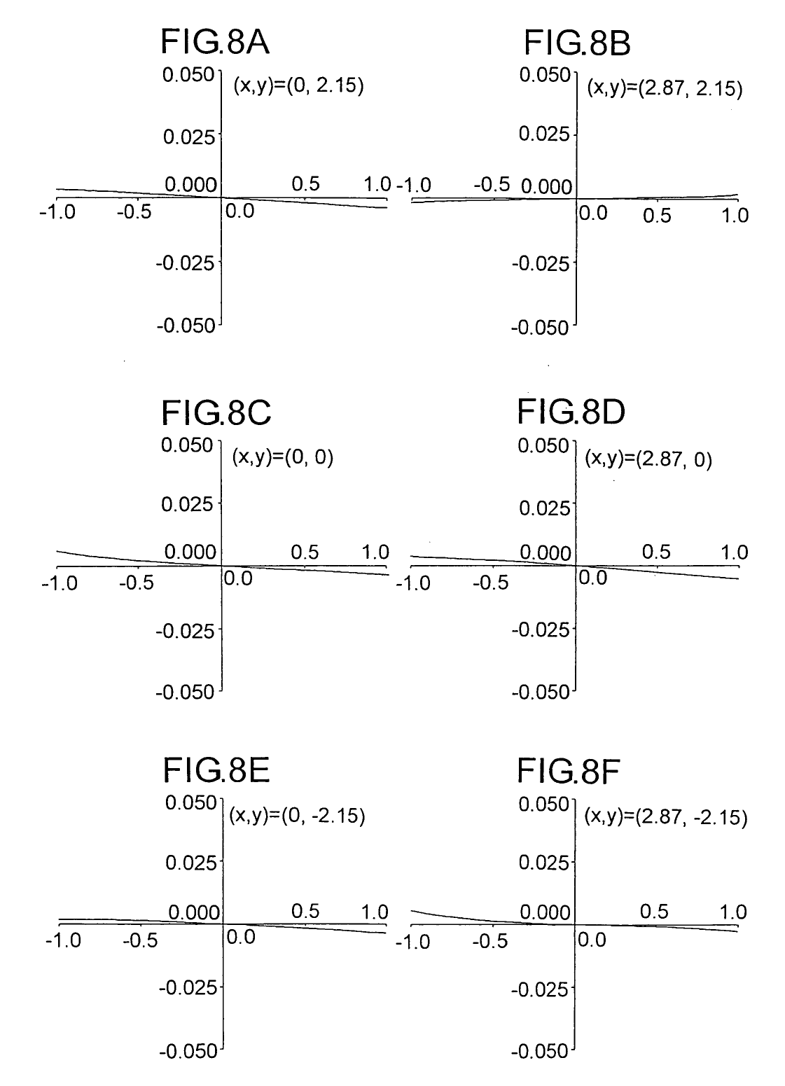

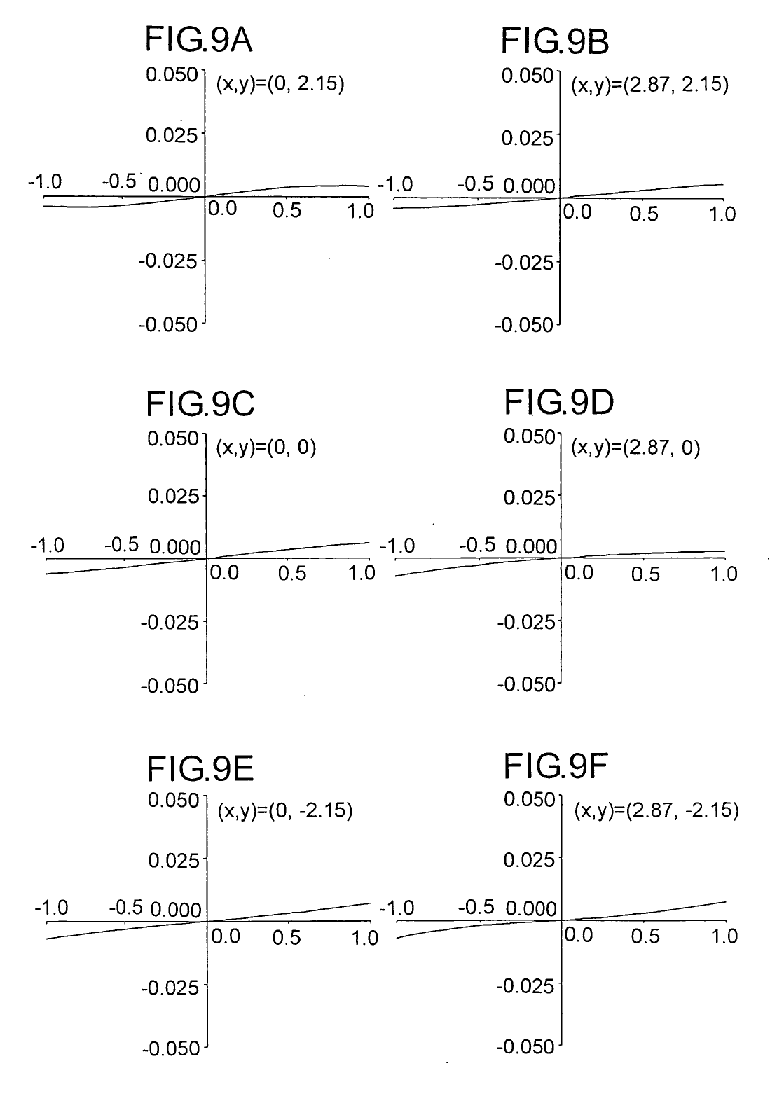

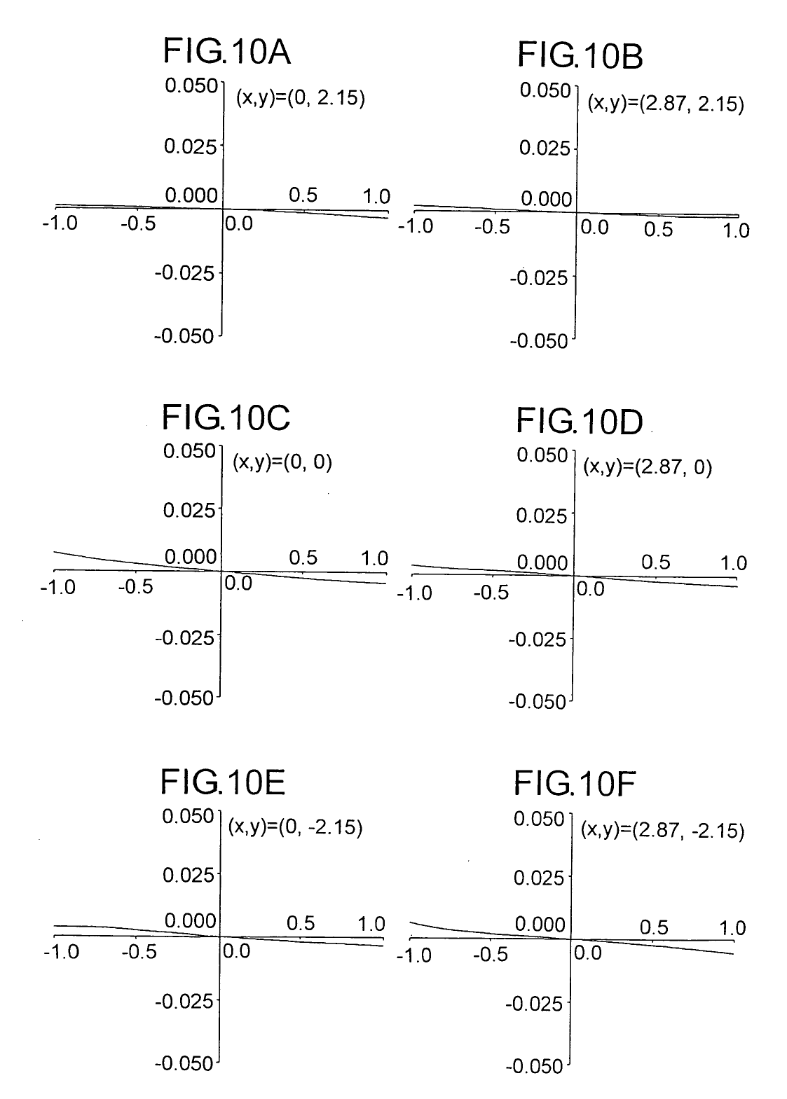

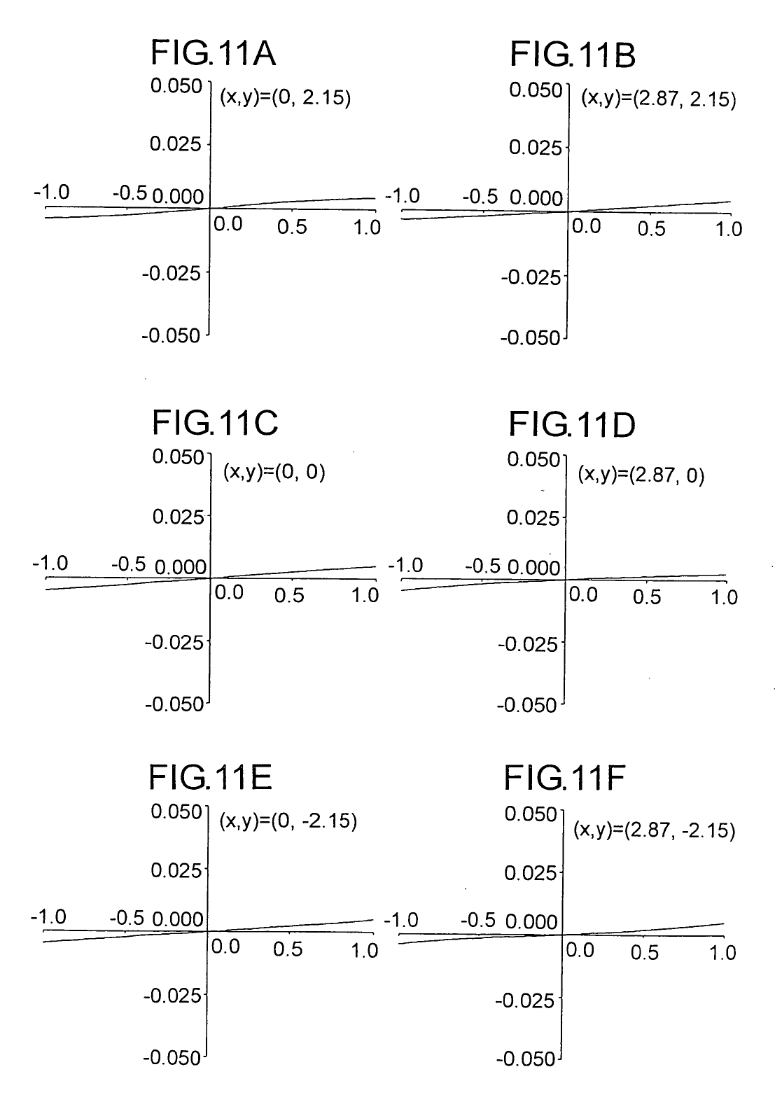

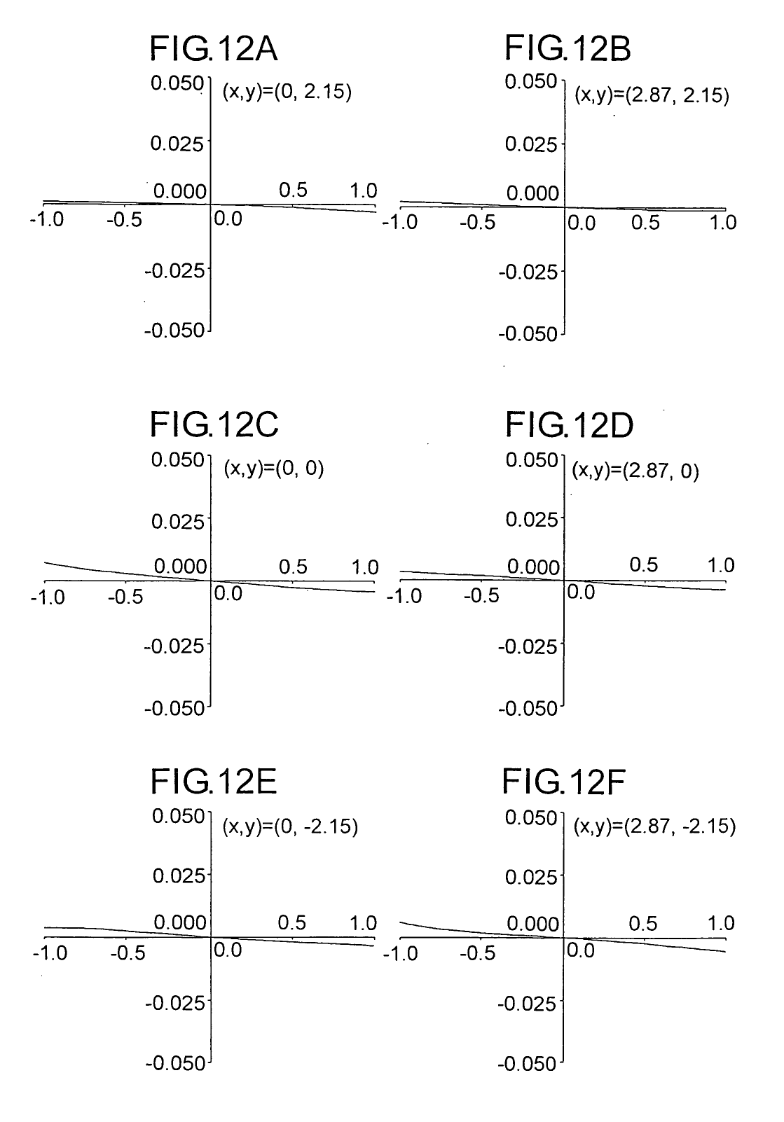

FIGS. 5A to 5F and 12A to 12F show lateral aberration diagrams for Examples 1 to 4. FIGS. 5A to 5F, 7A to 7F, 9A to 9F, and 11A to 11F show lateral aberration diagrams in the X direction. FIGS. 6A to 6F, 8A to 8F, 10A to 10F and 12A to 12F show lateral aberration in the Y direction. Each aberration diagram shown in FIGS. 5A to 5F through 12A to 12F indicates lateral aberration (in mm) for the d-line at the image height (in mm) represented by a local orthogonal coordinates (x, y). The scale of the aberration diagrams is −0.050 to 0.050 for the vertical axis and −1.0 to 1.0 for the horizontal axis.

The present invention can provide an image-taking optical system that is low-cost and very slim and also that offers a high performance for an image sensor having a great number of pixels. The use of the image-taking optical apparatus according to the invention in appliances such as digital cameras and personal digital assistants can contribute to performance enhancement, function enhancement, downsizing, cost reduction, and the like of these appliances.

TABLE 1
Example 1

| | | | | Optical |
|---|---|---|---|---|
| Si | ri[mm] | Ni | νi | Element |
| S1* | −8.637 | 1.583 | 30.2 | PR |
| S2* | 11.365 (Reflection Surface) | 1.583 | 30.2 | |
| S3* | −8.098 (Reflection Surface) | 1.583 | 30.2 | ST |
| S4* | −4.345 (Reflection Surface) | 1.583 | 30.2 | |
| S5* | −21.078 | Air | | |
| S6 | ∞ | 1.517 | 64.2 | PT |

| | | | |
|---|---|---|---|
| S7 | ∞ | Air | |
| S8 | ∞ (Image Surface) | | SR |

TABLE 2
Example 1

| | Vertex | | | | | |
|---|---|---|---|---|---|---|
| | Coordinates | | | Angle of Rotation | | |
| Si | X | Y | Z | X Rot. | Y Rot. | Z Rot. |
| S1 | 0 | 0 | 0 | 0 | 0 | 0 |
| S2 | 0 | 0 | 3.933 | −39.00 | 0 | 0 |
| S3 | 0 | 7.360 | 1.473 | 258.55 | 0 | 0 |
| S4 | 0 | 5.888 | 0 | 205.94 | 0 | 0 |
| S5 | 0 | 5.709 | 4.400 | 0 | 0 | 0 |
| S6 | 0 | 5.788 | 4.600 | 0 | 0 | 0 |
| S7 | 0 | 5.788 | 4.900 | 0 | 0 | 0 |
| S8 | 0 | 5.788 | 5.146 | 0 | 0 | 0 |

TABLE 3
Example 1
Free Curved Surface Coefficients of S1

| | | | | | |
|---|---|---|---|---|---|
| C4 | 1.018E−01 | C6 | 1.008E−01 | C8 | 4.493E−04 |
| C10 | 4.032E−05 | C11 | 2.330E−04 | C13 | 3.612E−04 |
| C15 | 1.150E−05 | | | | |

Free Curved Surface Coefficients of S2

| | | | | | |
|---|---|---|---|---|---|
| C3 | −5.670E−02 | C4 | −4.208E−02 | C6 | −3.947E−02 |
| C8 | 3.297E−04 | C10 | 4.353E−04 | C11 | −7.757E−05 |
| C13 | −1.158E−04 | C15 | −4.773E−05 | C17 | −6.743E−06 |
| C19 | 3.942E−06 | C21 | 5.549E−06 | C22 | −9.182E−07 |
| C24 | −2.566E−06 | C26 | −1.312E−06 | C28 | −8.584E−08 |

Free Curved Surface Coefficients of S3

| | | | | | |
|---|---|---|---|---|---|
| C3 | −6.614E−03 | C4 | 7.499E−02 | C6 | 8.861E−02 |
| C8 | −2.457E−04 | C10 | −8.436E−04 | C11 | 1.595E−04 |
| C13 | 4.688E−04 | C15 | 4.798E−04 | C17 | 4.363E−06 |
| C19 | −5.217E−05 | C21 | −8.696E−05 | C22 | 2.605E−05 |
| C24 | 1.300E−04 | C26 | 8.276E−05 | C28 | 3.894E−05 |

Free Curved Surface Coefficients of S4

| | | | | | |
|---|---|---|---|---|---|
| C3 | 1.383E−02 | C4 | 9.418E−02 | C6 | 1.191E−01 |
| C8 | −1.281E−03 | C10 | −1.342E−03 | C11 | 1.419E−03 |
| C13 | 2.830E−03 | C15 | 1.983E−03 | C17 | 4.282E−05 |
| C19 | 1.254E−05 | C21 | −3.943E−04 | C22 | 5.873E−05 |
| C24 | 1.600E−04 | C26 | 1.101E−04 | C28 | 1.728E−04 |

Free Curved Surface Coefficients of S5

| | | | | | |
|---|---|---|---|---|---|
| C3 | −2.864E−02 | C4 | −4.597E−02 | C6 | −2.333E−02 |
| C8 | −4.300E−03 | C10 | −3.968E−03 | C11 | 3.251E−03 |
| C13 | 9.018E−03 | C15 | 7.666E−03 | C17 | 2.450E−04 |
| C19 | −1.427E−03 | C21 | 8.508E−04 | C22 | 8.356E−05 |
| C24 | 8.189E−06 | C26 | −6.080E−04 | C28 | 2.948E−03 |
| C37 | −5.374E−06 | C45 | −1.962E−05 | C56 | −2.252E−06 |
| C66 | −1.144E−04 | | | | |

TABLE 4
Example 2

| | | | | Optical |
|---|---|---|---|---|
| Si | ri[mm] | Ni | νi | Element |
| S1* | −8.636 | 1.734 | 51.5 | PR |
| S2* | 11.388 (Reflection Surface) | 1.734 | 51.5 | |
| S3* | −8.024 (Reflection Surface) | 1.734 | 51.5 | ST |
| S4* | −4.367 (Reflection Surface) | 1.734 | 51.5 | |
| S5* | −41.607 | Air | | |
| S6 | ∞ | 1.517 | 64.2 | PT |

| S7 | ∞ | Air | |
|---|---|---|---|
| S8 | ∞ (Image Surface) | | SR |

TABLE 5
Example 2

| | Vertex | | | | | |
|---|---|---|---|---|---|---|
| | Coordinates | | | Angle of Rotation | | |
| Si | X | Y | Z | X Rot. | Y Rot. | Z Rot. |
| S1 | 0 | 0 | 0 | 0 | 0 | 0 |
| S2 | 0 | 0 | 3.794 | −39.00 | 0 | 0 |
| S3 | 0 | 7.345 | 1.399 | 258.53 | 0 | 0 |
| S4 | 0 | 5.866 | 0 | 206.03 | 0 | 0 |
| S5 | 0 | 5.744 | 4.200 | 0 | 0 | 0 |
| S6 | 0 | 5.814 | 4.400 | 0 | 0 | 0 |
| S7 | 0 | 5.814 | 4.700 | 0 | 0 | 0 |
| S8 | 0 | 5.814 | 5.100 | 0 | 0 | 0 |

TABLE 6
Example 2
Free Curved Surface Coefficients of S1

| | | | | | |
|---|---|---|---|---|---|
| C3 | −1.006E−04 | C4 | 9.961E−02 | C6 | 9.976E−02 |
| C8 | 5.455E−04 | C10 | 1.486E−05 | C11 | 2.260E−04 |
| C13 | 3.503E−04 | C15 | 2.149E−05 | C17 | 2.044E−07 |
| C19 | 2.109E−07 | C21 | −3.792E−09 | C22 | 4.118E−09 |
| C24 | 4.208E−08 | C26 | 6.373E−08 | C28 | −2.034E−09 |

Free Curved Surface Coefficients of S2

| | | | | | |
|---|---|---|---|---|---|
| C3 | −5.295E−02 | C4 | −4.218E−02 | C6 | −3.938E−02 |
| C8 | 3.780E−04 | C10 | 4.393E−04 | C11 | −7.912E−05 |
| C13 | −1.175E−04 | C15 | −4.769E−05 | C17 | −7.480E−06 |
| C19 | 4.630E−06 | C21 | 5.365E−06 | C22 | −9.332E−07 |
| C24 | −2.432E−06 | C26 | −1.087E−06 | C28 | −7.176E−08 |

Free Curved Surface Coefficients of S3

| | | | | | |
|---|---|---|---|---|---|
| C3 | −6.320E−03 | C4 | 7.417E−02 | C6 | 8.826E−02 |
| C8 | −1.317E−04 | C10 | −6.469E−04 | C11 | 1.131E−04 |
| C13 | 4.485E−04 | C15 | 4.833E−04 | C17 | 1.663E−05 |
| C19 | −1.835E−05 | C21 | −8.119E−05 | C22 | 1.565E−05 |
| C24 | 6.227E−05 | C26 | 5.617E−05 | C28 | 4.093E−05 |

Free Curved Surface Coefficients of S4

| | | | | | |
|---|---|---|---|---|---|
| C3 | 1.213E−02 | C4 | 9.621E−02 | C6 | 1.194E−01 |
| C8 | −1.070E−03 | C10 | −8.601E−04 | C11 | 1.387E−03 |
| C13 | 2.985E−03 | C15 | 2.65E−03 | C17 | 6.197E−05 |
| C19 | 1.309E−05 | C21 | −4.193E−04 | C22 | 6.444E−05 |
| C24 | 1.598E−04 | C26 | 2.443E−05 | C28 | 2.432E−04 |

Free Curved Surface Coefficients of S5

| | | | | | |
|---|---|---|---|---|---|
| C3 | −3.081E−02 | C4 | −3.058E−02 | C6 | −5.957E−03 |
| C8 | −1.533E−03 | C10 | −5.849E−03 | C11 | 2.192E−03 |
| C13 | 5.444E−03 | C15 | 4.364E−03 | C17 | 1.593E−04 |
| C19 | −8.487E−04 | C21 | 1.338E−03 | C22 | 1.250E−04 |
| C24 | 1.088E−04 | C26 | −1.605E−04 | C28 | 2.342E−03 |
| C37 | −5.936E−07 | C45 | −1.173E−04 | C56 | −1.979E−06 |
| C66 | −1.103E−04 | | | | |

TABLE 7
Example 3

| | | | | Optical |
|---|---|---|---|---|
| Si | ri[mm] | Ni | νi | Element |
| S1* | −8.635 | 1.583 | 30.2 | PR |
| S2* | 11.373 (Reflection Surface) | 1.583 | 30.2 | |
| S3* | −8.080 (Reflection Surface) | 1.583 | 30.2 | ST |
| S4* | −4.349 (Reflection Surface) | 1.583 | 30.2 | |
| S5* | −24.029 | Air | | |
| S6 | ∞ | 1.517 | 64.2 | PT |

| | | | |
|---|---|---|---|
| S7 | ∞ | Air | |
| S8 | ∞ (Image Surface) | | SR |

TABLE 8
Example 3

| | Vertex | | | | | |
|---|---|---|---|---|---|---|
| | Coordinates | | | Angle of Rotation | | |
| Si | X | Y | Z | X Rot. | Y Rot | Z Rot. |
| S1 | 0 | 0 | 0 | 0 | 0 | 0 |
| S2 | 0 | 0 | 3.827 | −39.00 | 0 | 0 |
| S3 | 0 | 7.370 | 1.380 | 259.00 | 0 | 0 |
| S4 | 0 | 5.914 | 0 | 206.14 | 0 | 0 |
| S5 | 0 | 5.729 | 4.200 | 0 | 0 | 0 |
| S6 | 0 | 5.835 | 4.400 | 0 | 0 | 0 |
| S7 | 0 | 5.835 | 4.700 | 0 | 0 | 0 |
| S8 | 0 | 5.835 | 5.253 | 0 | 0 | 0 |

TABLE 9
Example 3
Free Curved Surface Coefficients of S1

| | | | | | |
|---|---|---|---|---|---|
| C3 | 4.720E−03 | C4 | 1.000E−01 | C6 | 9.943E−02 |
| C8 | 5.049E−04 | C10 | 4.068E−06 | C11 | 2.256E−04 |
| C13 | 3.243E−04 | C15 | 7.619E−06 | C17 | −1.199E−06 |
| C19 | −3.880E−07 | C21 | 1.004E−06 | C22 | 2.569E−08 |
| C24 | 5.480E−07 | C26 | −8.883E−08 | C28 | −1.674E−07 |

Free Curved Surface Coefficients of S2

| | | | | | |
|---|---|---|---|---|---|
| C3 | −5.425E−02 | C4 | −4.213E−02 | C6 | −3.940E−02 |
| C8 | 3.288E−04 | C10 | 4.407E−04 | C11 | −7.407E−05 |
| C13 | −1.185E−04 | C15 | −4.778E−05 | C17 | −7.652E−06 |
| C19 | 5.042E−06 | C21 | 5.506E−06 | C22 | −9.984E−07 |
| C24 | −2.631E−06 | C26 | −1.155E−06 | C28 | −1.069E−07 |

Free Curved Surface Coefficients of S3

| | | | | | |
|---|---|---|---|---|---|
| C3 | −4.867E−03 | C4 | 7.478E−02 | C6 | 8.850E−02 |
| C8 | −1.764E−04 | C10 | −7.147E−04 | C11 | 7.681E−05 |
| C13 | 4.154E−04 | C15 | 4.574E−04 | C17 | 3.686E−05 |
| C19 | −2.367E−05 | C21 | −6.383E−05 | C22 | 1.246E−05 |
| C24 | 1.506E−04 | C26 | 7.894E−05 | C28 | 3.722E−05 |

Free Curved Surface Coefficients of S4

| | | | | | |
|---|---|---|---|---|---|
| C3 | 1.090E−02 | C4 | 9.521E−02 | C6 | 1.186E−01 |
| C8 | −1.041E−03 | C10 | −1.046E−03 | C11 | 1.335E−03 |
| C13 | 2.777E−03 | C15 | 1.998E−03 | C17 | 8.092E−05 |
| C19 | −2.159E−05 | C21 | −4.443E−04 | C22 | 5.205E−05 |
| C24 | 1.842E−04 | C26 | 7.677E−05 | C28 | 2.157E−04 |

Free Curved Surface Coefficients of S5

| | | | | | |
|---|---|---|---|---|---|
| C3 | −2.372E−02 | C4 | −4.260E−02 | C6 | −1.671E−02 |
| C8 | −3.239E−03 | C10 | −8.648E−03 | C11 | 3.498E−03 |
| C13 | 8.097E−03 | C15 | 7.011E−03 | C17 | 4.246E−04 |
| C19 | −1.277E−03 | C21 | 1.531E−03 | C22 | 1.021E−04 |
| C24 | 9.280E−05 | C26 | −3.519E−04 | C28 | 2.426E−03 |
| C37 | −1.623E−06 | C45 | −1.110E−04 | C56 | −1.682E−06 |
| C66 | −1.050E−04 | | | | |

TABLE 10
Example 4

| | | | | Optical |
|---|---|---|---|---|
| Si | ri[mm] | Ni | νi | Element |
| S1* | −8.635 | 1.583 | 30.2 | PR |
| S2* | 11.373 (Reflection Surface) | 1.583 | 30.2 | |
| S3* | −8.080 (Reflection Surface) | 1.583 | 30.2 | ST |
| S4* | −4.349 (Reflection Surface) | 1.583 | 30.2 | |
| S5* | −24.029 | Air | | |
| S6 | ∞ | 1.517 | 64.2 | PT |

| | | | |
|---|---|---|---|
| S7 | ∞ | Air | |
| S8 | ∞ (Image Surface) | | SR |

TABLE 11
Example 4

| | Vertex | | | | | |
|---|---|---|---|---|---|---|
| | Coordinates | | | Angle of Rotation | | |
| Si | X | Y | Z | X Rot. | Y Rot. | Z Rot. |
| S1 | 0 | 0 | 0 | 0 | 0 | 0 |
| S2 | 0 | 0 | 3.827 | −39.00 | 0 | 0 |
| S3 | 0 | 7.370 | 1.380 | 259.00 | 0 | 0 |
| S4 | 0 | 5.914 | 0 | 206.14 | 0 | 0 |
| S5 | 0 | 5.729 | 4.200 | 0 | 0 | 0 |
| S6 | 0 | 5.835 | 4.400 | 0 | 0 | 0 |
| S7 | 0 | 5.835 | 4.700 | 0 | 0 | 0 |
| S8 | 0 | 5.835 | 5.253 | 0 | 0 | 0 |

TABLE 12
Example 4
Free Curved Surface Coefficients of S1

| | | | | | |
|---|---|---|---|---|---|
| C3 | 4.720E−03 | C4 | 1.000E−01 | C6 | 9.943E−02 |
| C8 | 5.049E−04 | C10 | 4.068E−06 | C11 | 2.256E−04 |
| C13 | 3.243E−04 | C15 | 7.619E−06 | C17 | −1.199E−06 |
| C19 | −3.880E−07 | C21 | 1.004E−06 | C22 | 2.569E−08 |
| C24 | 5.480E−07 | C26 | −8.883E−08 | C28 | −1.674E−07 |

Free Curved Surface Coefficients of S2

| | | | | | |
|---|---|---|---|---|---|
| C3 | −5.425E−02 | C4 | −4.213E−02 | C6 | −3.940E−02 |
| C8 | 3.288E−04 | C10 | 4.407E−04 | C11 | −7.407E−05 |
| C13 | −1.185E−04 | C15 | −4.778E−05 | C17 | −7.652E−06 |
| C19 | 5.042E−06 | C21 | 5.506E−06 | C22 | −9.984E−07 |
| C24 | −2.631E−06 | C26 | −1.155E−06 | C28 | −1.069E−07 |

Free Curved Surface Coefficients of S3

| | | | | | |
|---|---|---|---|---|---|
| C3 | −4.867E−03 | C4 | 7.478E−02 | C6 | 8.850E−02 |
| C8 | −1.764E−04 | C10 | −7.147E−04 | C11 | 7.681E−05 |
| C13 | 4.154E−04 | C15 | 4.574E−04 | C17 | 3.686E−05 |
| C19 | −2.367E−05 | C21 | −6.383E−05 | C22 | 1.246E−05 |
| C24 | 1.506E−04 | C26 | 7.894E−05 | C28 | 3.722E−05 |

Free Curved Surface Coefficients of S4

| | | | | | |
|---|---|---|---|---|---|
| C3 | 1.090E−02 | C4 | 9.521E−02 | C6 | 1.186E−01 |
| C8 | −1.041E−03 | C10 | −1.046E−03 | C11 | 1.335E−03 |
| C13 | 2.777E−03 | C15 | 1.998E−03 | C17 | 8.092E−05 |
| C19 | −2.159E−05 | C21 | −4.443E−04 | C22 | 5.205E−05 |
| C24 | 1.842E−04 | C26 | 7.677E−05 | C28 | 2.157E−04 |

Free Curved Surface Coefficients of S5

| | | | | | |
|---|---|---|---|---|---|
| C3 | −2.372E−02 | C4 | −4.260E−02 | C6 | −1.671E−02 |
| C8 | −3.239E−03 | C10 | −8.648E−03 | C11 | 3.498E−03 |
| C13 | 8.097E−03 | C15 | 7.011E−03 | C17 | 4.246E−04 |
| C19 | −1.277E−03 | C21 | 1.531E−03 | C22 | 1.021E−04 |
| C24 | 9.280E−05 | C26 | −3.519E−04 | C28 | 2.426E−03 |
| C37 | −1.623E−06 | C45 | −1.110E−04 | C56 | −1.682E−06 |
| C66 | −1.050E−04 | | | | |

TABLE 13

| | | | Aperture | | | Image-Sensing | | |
|---|---|---|---|---|---|---|---|---|
| | | | Stop | Half Angle | | Surface | | Formula |
| | f | | Diameter | of View (deg.) | | Size (mm) | | (1), (1a) |
| Ex. | (mm) | FNO | (mm) | X Dir. | Y Dir. | X Dir. | Y Dir. | D/H |
| 1 | 6 | 2.9 | φ 1.58 | 25.54 | 19.7 | 5.74 | 4.3 | 1.28 |
| 2 | 6 | 2.8 | φ 1.58 | 25.54 | 19.7 | 5.74 | 4.3 | 1.27 |
| 3 | 6 | 3.0 | φ 1.58 | 25.54 | 19.7 | 5.74 | 4.3 | 1.31 |
| 4 | 6 | 3.5 | φ 1.18(X Dir.) | 25.54 | 19.7 | 5.74 | 4.3 | 1.31 |
| | | | φ 1.58(Y Dir.) | | | | | |

What is claimed is:

1. An image-taking optical system for forming an optical image of an object on a light-receiving surface of an image sensor, comprising:
at least one optical prism in which light from an object side enters through an entrance surface, is then reflected by at least three reflection surfaces each formed with a curved surface, and subsequently exits from an exit surface,
wherein at least one of the reflection surfaces is provided with an optical aperture stop, and
wherein at least one of the reflection surfaces is a rotationally asymmetrical surface so arranged as to be off-centered.

2. The image-taking optical system as claimed in claim 1,
wherein only one optical prism is provided.

3. The image-taking optical system as claimed in claim 1,
wherein conditional formula (1) below is fulfilled:
D/H<2.0 (1)
where
H represents a length of a screen of the image sensor along a shorter side thereof, and
D represents a length in a direction perpendicular to the screen of the image sensor from the image sensor to an intersection, among intersections of the prism surfaces and rays of light, which is located on a most object side in the direction perpendicular to the screen of the image sensor.

4. The image-taking optical system as claimed in claim 1,
wherein conditional formula (1a) below is fulfilled:
D/H<1.5 (1a)
where
H represents a length of a screen of the image sensor along a shorter side thereof, and
D represents a length in a direction perpendicular to the screen of the image sensor from the image sensor to an intersection, among intersections of the prism surfaces and rays of light, which is located on a most object side in the direction perpendicular to the screen of the image sensor.

5. The image-taking optical system as claimed in claim 1,
wherein the curved surface is a free curved surface.

6. The image-taking optical system as claimed in claim 1,
wherein the optical aperture stop is formed into a shape different from a circular shape.

7. The image-taking optical system as claimed in claim 1,
wherein the optical aperture stop is formed into an oval shape.

8. An image-taking lens apparatus comprising an image-taking optical system for forming an optical image and an image sensor for converting into an electrical signal the optical image formed by the image-taking lens system,
wherein the image-taking optical system comprises at least one optical prism in which light from an object side enters through an entrance surface, is then reflected by at least three reflection surfaces each formed with a curved surface, and subsequently exits from an exit surface,
wherein at least one of the reflection surfaces is provided with an optical aperture stop, and
wherein at least one of the reflection surfaces is a rotationally asymmetrical surface so arranged as to be off-centered.

9. The image-taking lens apparatus as claimed in claim 8,
wherein only one optical prism is provided.

10. The image-taking lens apparatus as claimed in claim 8,
wherein conditional formula below is fulfilled:
D/H<2.0 (1)
where
H represents a length of a screen of the image sensor along a shorter side thereof, and
D represents a length in a direction perpendicular to the screen of the image sensor from the image sensor to an intersection, among intersections of the prism surfaces and rays of light, which is located on a most object side in the direction perpendicular to the screen of the image sensor.

11. The image-taking lens apparatus as claimed in claim 8,
wherein conditional formula (1a) below is fulfilled:
D/H<1.5 (1a)
where
H represents a length of a screen of the image sensor along a shorter side thereof, and
D represents a length in a direction perpendicular to the screen of the image sensor from the image sensor to an intersection, among intersections of the prism surfaces and rays of light, which is located on a most object side in the direction perpendicular to the screen of the image sensor.

12. The image-taking lens apparatus as claimed in claim 8,
wherein the curved surface is a free curved surface.

13. The image-taking lens apparatus as claimed in claim 8,
wherein the optical aperture stop is formed into a shape different from a circular shape.

14. The image-taking lens apparatus as claimed in claim 8,
wherein the optical aperture stop is formed into an oval shape.
